(19) United States
(12) Patent Application Publication
(10) Pub. No.: US 2024/0262944 A1
(43) Pub. Date: Aug. 8, 2024

(54) POLYPROPYLENE-BASED COMPOSITIONS WITH IMPROVED IMPACT RESISTANCE AND AESTHETIC PROPERTIES

(71) Applicant: Braskem S.A., Camaçari (BR)

(72) Inventors: Moisés Magalhães Werlang, São Paulo City (BR); Joel Matthew Carr, Pittsburgh, PA (US); William Scott Miller, Pittsburgh, PA (US)

(73) Assignee: Braskem S.A., Camaçari (BR)

(21) Appl. No.: 18/402,874

(22) Filed: Jan. 3, 2024

Related U.S. Application Data
(60) Provisional application No. 63/443,938, filed on Feb. 7, 2023.

(51) Int. Cl. C08F 110/06; C08F 2/02; C08J 3/12; C08K 3/34; C08L 23/16

(52) U.S. Cl. CPC C08F 110/06; C08F 2/02; C08J 3/12; C08K 3/34; C08L 23/16; C08J 2323/12; C08J 2323/16; C08L 2205/22

(57) ABSTRACT

An impact copolymer polypropylene composition may include a polypropylene-based matrix polymer; and from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and wherein the ICP composition has an Izod impact strength ranging from 180 to 600 J/m, as measured according to ASTM D256A at −20° C.

### BACKGROUND

Tiger (flow) marking is defined as a viscoelastic melt flow instability that typically occurs in relatively long injection molded parts, where alternate dull and glossy regions occur beyond a certain distance from the gate (onset distance to flow marks). In different applications that utilize impact copolymers (ICPs), it is highly desirable to delay (and ideally eliminate) the onset of tiger/flow marking as far away from the gate of injection molded parts as possible. In order to achieve enhanced tiger marking performance of ICP compositions, introduction of a very high molecular weight (MW) (or equivalently high intrinsic viscosity (I.V.) rubber phase, e.g., ethylene-propylene (EPR) copolymer or a copolymer of propylene with other alpha-olefins) is often required, which results in a high viscosity ratio between the rubber phase and the matrix (e.g., propylene-based polymer such as homopolymer polypropylene (HPP)), causing a high count of large polymeric gels that are detrimental to surface appearance and final part paintability. Further, ICP compositions including a very high MW or IV rubber phase often exhibit reduced impact resistance compared to conventional ICP compositions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an impact copolymer polypropylene composition that includes a polypropylene-based matrix polymer; and from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and wherein the ICP composition has an Izod impact strength ranging from 180 to 600 J/m, as measured according to ASTM D256A at −20° C.

In another aspect, embodiments disclosed herein relate to an article that includes an impact copolymer polypropylene composition that includes a polypropylene-based matrix polymer; and from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and wherein the ICP composition has an Izod impact strength ranging from 180 to 600 J/m, as measured according to ASTM D256A at −20° C.

In another aspect, embodiments disclosed herein relate to a thermoplastic polyolefin (TPO) composition that includes an impact copolymer polypropylene (ICP) composition; and a polypropylene homopolymer; wherein the TPO has an MFR ranging from 5.0 to 30 g/10 min, as measured according to ASTM D1238 at 230° C. under a 2.16 kg load, and the impact copolymer polypropylene composition include a polypropylene-based matrix polymer; and from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and wherein the ICP composition has an Izod impact strength ranging from 180 to 600 J/m, as measured according to ASTM D256A at −20° C.

In yet another aspect, embodiments disclosed herein relate to an article that includes a thermoplastic polyolefin (TPO) composition that includes an impact copolymer polypropylene (ICP) composition; and a polypropylene homopolymer; wherein the TPO has an MFR ranging from 5.0 to 30 g/10 min, as measured according to ASTM D1238 at 230° C. under a 2.16 kg load, and the impact copolymer polypropylene composition include a polypropylene-based matrix polymer; and from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and wherein the ICP composition has an Izod impact strength ranging from 180 to 600 J/m, as measured according to ASTM D256A at −20° C.

In yet another aspect, embodiments disclosed herein relate to a method of making an impact copolymer polypropylene (ICP) composition that includes polymerizing polypropylene via a bulk polymerization slurry process to provide a polypropylene-based polymer; and polymerizing an ethylene-propylene rubber (EPR) phase in the presence of the polypropylene-based polymer and a highly porous organic catalyst to provide the EPR phase dispersed within the polypropylene-based polymer to produce an impact copolymer polypropylene composition that includes a polypropylene-based matrix polymer; and from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and wherein the ICP composition has an Izod impact strength ranging from 180 to 600 J/m, as measured according to ASTM D256A at −20° C.

Other aspects and advantages of the claimed subject matter will be apparent from the following description and the appended claims.

### DETAILED DESCRIPTION

Embodiments disclosed herein relate to impact copolymer polypropylene (ICP) compositions with improved impact resistance and reduced tiger markings, methods of producing the same, and thermoplastic polyolefins comprising such composition.

### ICP Composition

In one aspect, embodiments disclosed herein relate to ICP compositions. ICP compositions in accordance with the present disclosure may also be referred to as “heterophasic polypropylene” containing a continuous matrix (continuous phase) and an elastomeric rubber phase (also known as internal rubber phase or discontinuous phase). ICPs are generated by incorporating an elastomeric rubber phase into a matrix polymer, which results in a polymer composition having modified bulk properties, including noticeable changes in impact resistance and modulus.

In one or more embodiments, the ICP composition include a polypropylene-based matrix polymer and an ethylene-propylene copolymer rubber (EPR) phase dispersed therein.

### Matrix Polymer

ICP compositions in accordance with the present disclosure may include a matrix polymer phase composed of polypropylene-based polymer. The matrix polymer may be a polypropylene homopolymer or a propylene copolymer. In one or more embodiments, the matrix polymer may be monomodal or bimodal.

In one or more embodiments, a matrix polymer may be a propylene copolymer having 5 wt % or less of comonomer selected from any of one or more of ethylene and C4 to C1O alkenes, including linear monomers such as alpha-olefins and comonomers with various degrees of branching.

In one or more embodiments, ICP polymer compositions may contain a percent by weight of the total composition (wt %) of matrix polymer ranging from a lower limit selected from one of 55 wt %, 60 wt %, and 65 wt %, to an upper limit selected from one of 70 wt %, 72 wt %, and 75 wt % wt %, where any lower limit can be used with any upper limit.

In one or more embodiments, the matrix polymer may have an MFR ranging from 50 to 250 g/10 min, as measured according to ASTM D1238 at 230° C. under a 2.16 kg load. For example, the matrix polymer may have an MFR ranging from a lower limit of one of 50, 75, 100, 125, and 150 g/10 min to an upper limit of one of 150, 175, 200, 225, and 250 g/10 min, where any lower limit may be can be combined with any upper limit.

In one or more embodiments, the matrix phase may have a fraction of xylene solubles, measured according to ASTM D5492, ranging from 2% to 7%.

### Elastomeric Rubber Phase

ICP compositions in accordance with the present disclosure may contain an elastomeric rubber phase (EPR) that is prepared from a propylene copolymer containing propylene and at least one comonomer selected from one or more of ethylene and C4 to C10 alkenes, including linear monomers such as alpha-olefins and comonomers with various degrees of branching.

In one or more embodiments, the elastomeric rubber phase is present in the ICP composition at a percent by weight (wt %) of the total composition ranging from a lower limit selected from any one of 25 wt %, 28 wt %, 30 wt %, and 35 wt %, to an upper limit selected from any one of 35 wt %, 40 wt %, 42 wt %, and 45 wt %, where any lower limit may be paired with any upper limit.

The EPR phase may include ethylene in an amount ranging from 30 to 38 wt %, based on the total weight of the EPR. For example, ethylene may be present in the EPR phase in an amount ranging from a lower limit of one of 30, 31, 32, 33, 34, and 35 wt % to an upper limit of one of 35, 36, 37, and 38 wt %, where any lower limit may be paired with any mathematically compatible upper limit.

In one or more embodiments, the EPR phase includes xylenes solubles (XS) in an amount ranging from 25 to 45 wt %, based on the total weight of the EPR phase. For example, the EPR phase may have an XS content ranging from a lower limit of one of 25, 30, and 35 wt % to an upper limit of one of 35, 40, and 45 wt %, where any lower limit may be paired with any mathematically compatible upper limit. The weight percentage XS fraction of the ICP composition was determined according to ASTM D5492 using 2 g of composition in 200 ml of xylene. The percentage XS fraction of the composition was determined as the difference of 100 minus the percentage XI.

In one or more embodiments, the EPR phase has a suitable amorphous IV. For instance, the amorphous IV of the EPR phase may be at least 6.0 dL/g, but not higher than 12.0 dL/g, as measured according to ASTM D445. For example, the EPR phase may have an amorphous IV ranging from a lower limit of one of 6.0, 7.0, 8.0, and 9.0 dL/g to an upper limit of one of 9.0, 10.0, 11.0 and 12.0 dL/g, where any lower limit may be paired with any mathematically compatible upper limit.

In one or more embodiments, the elastomeric rubber phase includes two distinct copolymer fractions (Fc1) and (Fc2) that are distinct in terms of reactor, monomer content, molecular weight, and/or intrinsic viscosity. For example, such copolymer fractions may be produced through a series of gas phase reactors, where a first gas phase reactor produces a first copolymer fraction (Fc1) and a second gas phase reactor produces a second copolymer fraction (Fc2).

In one or more embodiments, a first copolymer fraction (Fc1) may be present at 55 wt % to 75 wt % of the total EPR phase. For example, the first copolymer fraction may be present at a lower limit of any of 55, 58, or 60 wt %, to an upper limit of any of 70, 72, or 75 wt %, where any lower limit can be used with any upper limit.

The first copolymer fraction may include 30 to 40 wt % ethylene, based on the total weight of the first copolymer. For example, the first copolymer fraction may include ethylene in an amount ranging from a lower limit of one of 30, 31, 32, 33, 34, and 35 wt % to an upper limit of one of 36, 37, 38, 39, and 40 wt %, where any lower limit may be paired with any mathematically compatible upper limit.

In one or more embodiments, the first copolymer fraction is characterized in that it has an amorphous intrinsic viscosity (IV) of at least 2.0 dL/g, but not higher than 4.0 dL/g, as measured according to ASTM D445. The first copolymer fraction may have an amorphous IV ranging from a lower limit of one of 2.0, 2.2, 2.4, 2.6, 2.8, and 3.0 dL/g to an upper limit of one of 3.0, 3.2, 3.4, 3.6, 3.8, and 4.0 dL/g, where any lower limit may be paired with any mathematically compatible upper limit. The amorphous intrinsic viscosity of Fc1 is measured by precipitating the amorphous phase present at the xylene solubles in an acetone/ethanol blend (50/50 wt %) and filtering the precipitate, and the solid fraction is dried at 100° C. under N₂, and dissolved in decaline at 135° C. as determined by ASTM D445.

In one or more embodiments, a second copolymer fraction (Fc2) may be present at 25 wt % to 45 wt % of the total EPR phase. For example, the first copolymer fraction may be present at a lower limit of any of 25, 28, or 30 wt %, to an upper limit of any of 35, 40, or 45 wt %, where any lower limit can be used with any upper limit.

The second copolymer fraction may include 60 to 70 wt % propylene, based on the total weight of the first copolymer. For example, the second copolymer fraction may include ethylene in an amount ranging from a lower limit of one of 60, 61, 62, 63, 64, and 65 wt % to an upper limit of one of 66, 67, 68, 69, and 70 wt %, where any lower limit may be paired with any mathematically compatible upper limit.

In one or more embodiments, the second copolymer fraction may have an intrinsic viscosity (IV_{Fc2}) of at least 6.0 dL/g, but not higher than 12 dL/g, as measured according to ASTM D445. For example, the second copolymer fraction may have an IV ranging from a lower limit of one of 6.0, 7.0, 8.0, and 9.0 dL/g to an upper limit of one of 9.0, 10.0, 11.0 and 12.0 dL/g, where any lower limit may be paired with any mathematically compatible upper limit. Because the IV of the second copolymer fraction (IV/XS(Fc2)) cannot be measured directly, it can be calculated using the following formula:

$$IV / {XS}_{( F c 2 )} = [ ( I {V}_{total} * {w}_{total} ) - ( I {V}_{Fc 1} * {w}_{F c 1} ) ] / {w}_{F c 2}$$

where IVₜₒₜₐₗ dis the IV of the fraction soluble in xylene of the final composition
wₜₒₜₐₗ=100% EPR, where the sum of the polymer splits for the first and second reactors (30%+10%=40%) represents the total of EPR (100% EPR) produced
IV_{Fc1} is the IV of the fraction soluble in xylene produced in the first reactor
w_{Fc1} is the percentage of EPR produced in the first reactor based on 100% EPR [(30%_{polymer split for Fc1}*100% EPR total)/40%_{sum of polymer splits for Fc1 and Fc2}]

### Additives

In one or more embodiments, the ICP compositions (or TPO compositions discussed below) may contain a number of other functional additives that modify various properties of the composition such as antioxidants such as phenolic and phosphitic antioxidants, pigments, fillers such as calcium carbonate and kaolin clays, reinforcements, adhesion-promoting agents, biocides, whitening agents, nucleating agents, anti-statics, anti-blocking agents, processing aids such as low molecular weight polyethylene waxes, ester waxes, paraffin wax, paraffin oils, mineral oils, napthenic oils, bis-stearamides, stearamides, calcium stearate, and stearic acid, ultraviolet absorbers, lubricants, flame-retardants, plasticizers, light stabilizers, and the like.

In one or more embodiments, ICP compositions (or TPO compositions discussed below) may contain a percent by weight of the total composition (wt %) of one or more additives ranging from a lower limit selected from one of 0.001 wt %, 0.01 wt %, 0.05 wt %, 0.5 wt %, and 1 wt %, to an upper limit selected from one of 1.5 wt %, 2 wt %, 5 wt %, 7 wt %, and 15 wt % where any lower limit can be used with any upper limit. While a number of potential ranges for polymer additives have been introduced, the additives are not considered in the determination of the Emission Factor for the respective polymer composition.

As previously described, ICP compositions in accordance with the present disclosure may have unique characteristics. Such characteristics may be favorable in that they may provide ICP compositions with improved impact strength and delayed or eliminated tiger markings.

In one or more embodiments, the ICP composition has an Izod impact strength ranging from 180 to 600 J/m, as measured according to ASTM D256A at −20° C. For example, the Izod impact strength, measured at −20° C., of ICP compositions may range from a lower limit of one of 180, 200, 240, 280, 320, 360, and 400 J/m to an upper limit of one of 400, 440, 480, 520, 560, and 600 J/m where any lower limit may be paired with any mathematically compatible upper limit. The Izod impact strength of ICP compositions in accordance with the present disclosure may range from 80 to 120 J/m, as measured according to ASTM D256A at −40° C. As such, ICP compositions of one or more embodiments may have an Izod impact strength, measured at −40° C., ranging from a lower limit of one of 80, 85, 90, 95, and 100 J/m to an upper limit of one of 100, 105, 110, 115, and 120 J/m where any lower limit may be paired with any mathematically compatible upper limit.

In one or more embodiments, the ICP composition has a relatively high amorphous intrinsic viscosity (IV), due to, in part, the high ethylene content of the compositions. As such, ICP compositions in accordance with the present disclosure have an amorphous IV of at least 4.0 dL/g. For example, the ICP composition may have an amorphous IV of at least 4.0 dL/g, at least 5.0 dL/g, at least 6.0 dL/g, at least 7.0 dL/g, at least 8.0 dL/g, at least 9.0 dL/g, and at least 10.0 dL/g.

In one or more embodiments, the ICP composition has a melt flow rate (MFR) of 5.0 to 30.0 g/10 min, as measured according to ASTM D1238 at 230° C. under a 2.16 kg load. For example, the MFR of ICP compositions in accordance with the present disclosure may range from a lower limit of one of 5.0, 7.5, 10.0, 12.5, 15 and 17.5 g/10 min to an upper limit of one of 17.5, 20.0, 22.5, 25.0, 27.5, and 30.0 g/10 min where any lower limit may be paired with any mathematically compatible upper limit.

According to various embodiments, the ICP compositions of the present disclosure may display improved properties compared to conventional ICP compositions. For example, the ICP compositions may have a unique, differentiated rheological response at low angular frequencies, resulting in increased elasticity at these frequencies. In one or more embodiments, the ICP may have a tan 6 of less than 3.5 at 0.1 rad/s, measured by DMA analysis at 180° C. For example, the ICP may have a tan 6 of less than 3.5, 3.0, 2.0, or even less than 1.0 at 0.1 rad/s at 180° C.

ICP compositions disclosed herein may be included in the composition of various articles. Suitable articles that may be prepared using the ICP composition of one or more embodiments include, but are not limited to, automotive parts, appliances, and other injected parts.

### Method of Preparing ICP Composition

In another aspect, embodiments of the present disclosure relate to a method of preparing an ICP composition as previously described. Briefly, the method may include n a sequential polymerization process wherein a propylene based polymer (defined as the ICP “matrix’) is prepared first, followed by the preparation of a copolymer rubber (defined as the EPR phase).

In one or more embodiments, the method includes polymerizing polypropylene to provide a polypropylene-based polymer. The propylene-based polymer (matrix) may be prepared using at least one reactor and may be also prepared using a plurality of parallel reactors or reactors in series (stage 1). Preferably, the propylene-based polymer process utilizes one or two liquid filled loop reactors in series. The term liquid or bulk phase reactor as used herein is intended to encompass a liquid propylene process as described by Ser Van Ven in “Polypropylene and Other Polyolefins’, 1990, Elsevier Science Publishing Company, Inc., pp. 119-125 excluding herein a slurry/solvent process where the liquid is in an inert Solvent (e.g., hexane). Despite a preference for liquid filled loop reactors, the propylene polymer may also be prepared in a gas-phase reactor, a series of gas phase reactors or a combination of liquid filled loop reactors and gas phase reactors in any sequence as described in U.S. Pat. No. 7,217,772. The propylene-based polymer is preferably made in a unimodal molecular weight fashion, i.e., each reactor of stage 1 produces polymer of the same MFR/MW. However, a bimodal or multi modal propylene-based polymer may be also produced in the practice of the present disclosure.

In some embodiments, the propylene-based matrix polymer is provided by polymerizing propylene with a comonomer. In other embodiments, propylene is polymerized as a homopolymer. Examples of a suitable propylene-based matrix include, but are not limited to, homopolymer polypropylene and random ethylene-propylene or generally random propylene-alpha olefin copolymer, where the limited to, C4, C6 or C8 alpha olefins or combinations thereof. In particular embodiments, propylene-based matrix is a polypropylene homopolymer.

Once formation of the propylene-based (matrix) polymer is complete, the resultant powder is passed through a degassing stage before passing to one or more gas phase reactors (stage 2), wherein propylene is copolymerized with ethylene (C2) or an alpha-olefin co-monomer including, but not limited to, C4, C6 or C8 alpha olefins or combinations thereof, in the presence of the propylene-based polymer produced in stage 1 and the catalyst transferred therewith. In particular embodiments, to form a rubber phase having two (or more) distinct copolymer fractions, two (or more) gas phase reactors may be used to form the copolymers. Examples of gas phase reactors include, but are not limited to, a fluidized (horizontal or vertical) or stirred bed reactor or combinations thereof.

For the copolymerization reaction, the gas phase composition of the reactor(s) is maintained such that the ratio of the moles of ethylene (or alpha-olefin) in the gas phase to the total moles of ethylene (or alpha-olefin) and propylene is held constant. In order to maintain the desired molar ratio and bi-polymer content, monomer feed of propylene and ethylene (or alpha-olefin) is adjusted as appropriate.

In one or more embodiments, the copolymerization reaction is performed in the presence of a porous organic catalyst such as, for example, a porous phthalate, diether, succinate, or blends thereof. In particular embodiments, the copolymerization is carried out in the presence of a highly porous phthalate catalyst.

Such method of polymerization may provide an ICP composition as previously described, wherein an EPR phase as previously described is dispersed within a polypropylene-based polymer matrix.

Optionally, in one or more embodiments, the ICP composition prepared in accordance with methods of the present disclosure may be pelletized. In such embodiments, the pelletized ICP composition may be formed into various articles of manufacture that exhibit improved properties, such as, for example, increased impact resistance and reduced or eliminated tiger markings. Exemplary articles of manufacture include, but are not limited to, automotive parts.

### TPO Composition

In yet another aspect, embodiments of the present disclosure relate to a thermoplastic polyolefin (TPO) composition having improved impact strength and delayed or eliminated tiger striping.

In one or more embodiments, the TPO composition includes an impact copolymer of polypropylene as previously described. The TPO composition may include an ICP in an amount ranging from about 20 to about 65 wt %, based on the total weight of the TPO composition. For example, an ICP may be included in a TPO composition of one or more embodiments in an amount ranging from a lower limit of one of 20, 25, 30, 35, and 40 wt % to an upper limit of one of 40, 45, 50, 55, 60, and 65 wt %, where any lower limit may be paired with any mathematically compatible upper limit.

In one or more embodiments, the TPO composition includes a homopolymer. The homopolymer may be any homopolymer known by one of ordinary skill in the art that is commonly included in TPO compositions. Accordingly, the homopolymer may be one or more of polypropylene.

The TPO composition may include a homopolymer in an amount ranging from 10 to 50 wt %, based on the total amount of the TPO composition. For example, in one or more embodiments, a homopolymer is included in the TPO composition in an amount ranging from a lower limit of one of 10, 15, 20, 30, 35, or 40 wt % to an upper limit of one of 20, 25, 30, 35, 40, 45, or 50 wt %, where any lower limit may be paired with any mathematically compatible upper limit.

Optionally, in one or more embodiments, the TPO composition includes a polyolefin elastomer and/or talc. Any conventional polyolefin elastomer known by one of ordinary skill in the art may be included in the TPO composition. Exemplary polyolefin elastomers include, but are not limited to, ethylene-butene copolymers, ethylene-hexene copolymers, and ethylene-octene copolymers, such as ENGAGE™ or AFFINITY™ Polyolefin Elastomers commercially available from The Dow Chemical Company, Midland, Mich.: or EXACT™, VERSIFY™, or VISTAMAXX™ from ExxonMobil Chemical, Houston Tex.

In embodiments in which a polyolefin elastomer is included in the TPO composition, the polyolefin elastomer may be present in an amount ranging from 1 to 10 wt %, based on the total weight of the TPO composition. For example, in one or more embodiments, a polyolefin elastomer is included in the TPO composition in an amount ranging from a lower limit of one of 1, 2, 3, 4, and 5 wt % to an upper limit of one of 6, 7, 8, 9, and 10 wt %, where any lower limit may be paired with any mathematically compatible upper limit.

In embodiments in which talc is included in the TPO composition, the talc may be present in an amount ranging from 1 to 10 wt %, based on the total weight of the TPO composition. For example, in one or more embodiments, talc is included in the TPO composition in an amount ranging from a lower limit of one of 1, 2, 3, 4, and 5 wt % to an upper limit of one of 6, 7, 8, 9, 10, 15, and 20 wt %, where any lower limit may be paired with any mathematically compatible upper limit.

It is also envisioned that optionally a standard ICP is also included in the TPO composition. As defined herein, a standard ICP has 10-22% of XS and an IV from 2.2 to 3.2 dL/g. For example, in one or more embodiments, a standard ICP is included in the TPO composition in an amount ranging from a lower limit of one of 0, 1, 2, 3, 4, and 5 wt % to an upper limit of one of 6, 7, 8, 9, 10, 15, and 20 wt %, where any lower limit may be paired with any mathematically compatible upper limit.

The TPO including an ICP composition as presently described may have unique properties as compared to conventional TPO compositions. For example, TPO compositions in accordance with one or more embodiments may have improved impact strength and delayed or eliminated tiger striping.

In one or more embodiments, the TPO has an MFR similar to that of the included ICP. Accordingly, the TPO may have an MFR ranging from 5.0 to 30.0 g/10 min, as measured according to ASTM D1238 at 190 under a 2.16 kg load. For example, the TPO of some embodiments has an MFR ranging from a lower limit of one of 5.0, 7.5, 10.0, 12.5, 15 and 17.5 g/10 min to an upper limit of one of 17.5, 20.0, 22.5, 25.0, 27.5, and 30.0 g/10 min where any lower limit may be paired with any mathematically compatible upper limit.

In one or more embodiments, the TPO composition has a tan S of less than about 5. Dynamic frequency sweep isothermal data were generated with a controlled strain/stress rheometer with 25 mm parallel plates in a nitro gen purge to eliminate sample degradation. A frequency range of 0.1-300 rad/s was used at 1800 C and 2 mm gap with strain amplitudes (˜5-15%) lying within the linear viscoelastic region. The loss tangent (tan □6) at low angular frequency (e.g. 0.1 and 0.4 rad/s) of the composition is defined here as a metric of tiger marking performance of the standalone composition and its filled compound consistent with the work of Maeda et al. (2007) [Maeda, S., K. Fukunaga, and E. Kamei, “Flow mark in the injection molding of polypropylene/rubber/talc blends,” Nihon Reoroji Gakkaishi 35, 293-299 (2007)].

In one or more embodiments, the TPO composition has a tiger marking onset distance of at least 75%. It is highly desirable to delay (and ideally eliminate) the onset of tiger/flow marking as far away from the gate of injection molded parts as possible. Tiger (flow) marking is defined as a viscoelastic melt flow instability that typically occurs in relatively long injection molded parts, where alternate dull and glossy regions occur beyond a certain distance from the gate (onset distance to flow marks). The tiger marking performance is defined as “excellent” in this invention in terms of both the standalone composition and its filled compound (defined previously) as (i) no tiger marks present or visible on the plaque or (ii) onset distance of tiger marks is beyond a critical distance away from the gate (e.g., the distance between the gate and the first tiger mark is about 75% or more of the total length of the plaque). The tiger marking performance is defined as “poor” when tiger marks are visible with an onset distance of tiger marks from the gate of less than about 75% of the total length of the plaque. It was found that for an impact copolymer polypropylene composition of MFR >10 dg/min, a tan 6 at 0.1 rad/s (180° C.) of less than about 5 (standalone composition) resulted in excellent tiger marking performance for both the standalone composition and its filled compounds due to enhanced melt elasticity. A tiger marking ranking scale of 5-10 (worst to best) was also established based on visual observation of the plaques as follows: 9-10 “excellent” and 5-8 “poor.”

In one or more embodiments, the TPO has an impact strength such that no failure is exhibited when tested by falling dart test −20° C. according to ASTM D1709. Such impact strength may be improved over conventional TPO compositions that include an larger quantities of polyolefin elastomer.

In one or more embodiments, TPOs compositions may have an instrumented drop impact at −40° C., average percent ductility, measured according to ASTM D3763 higher than 60%. In some embodiments, compositions may have an instrumented drop impact at −30° C., average percent ductility, measured according to ASTM D3763 equal to 100

TPO compositions disclosed herein may be included in the composition of various articles. In one or more embodiments, the article is an automotive part such as, for example bumpers or other exterior or interior parts, appliances, and other injected parts.

TPO compositions in accordance with the present disclosure may be prepared by a number of possible polymer blending and formulation techniques, which will be discussed in the following sections. In one or more embodiments, the disclosed TPO composition is prepared by mixing an ICP composition with a homopolymer and optional filler or polyolefin elastomer. The ICP composition and the polyolefin elastomer may be combined by melt blending, for example.

In one or more embodiments, ICP polymer compositions may be combined with a secondary polymer composition (homopolymer and/or polyolefin elastomer) in a melt blend process. For example, the ICP polymer composition may be combined subsequently with a homopolymer and/or polyolefin elastomer, such as by a conventional extrusion process, for example, to blend the polymers together, thereby forming a TPO composition.

In one or more embodiments, TPO compositions in accordance with the present disclosure may be prepared using continuous or discontinuous extrusion. Methods may use single-, twin- or multi-screw extruders, which may be used at temperatures ranging from 100° C. to 270° C. in some embodiments, and from 140° C. to 230° C. in some embodiments. In some embodiments, raw materials are added to an extruder, simultaneously or sequentially, into the main or secondary feeder in the form of powder, granules, flakes or dispersion in liquids as solutions, emulsions and suspensions of one or more components.

TPO compositions prepared by extrusion may be in the form of granules or pellets that are applicable to different molding processes, including processes selected from extrusion molding, coextrusion molding, extrusion coating, injection molding, injection blow molding, inject stretch blow molding, thermoforming, cast film extrusion, blown film extrusion, foaming, extrusion blow-molding, injection stretched blow-molding, rotomolding, pultrusion, calendering, additive manufacturing, lamination, and the like, to produce manufactured articles. Optionally, in one or more embodiments, the TPO composition is pelletized.

In one or more embodiments, the article is an injection molded article, a thermoformed article, a film, a foam, a blow molded article, an additive manufactured article, a compressed article, a coextruded article, a laminated article, an injection blow molded article, a rotomolded article, an extruded article, monolayer articles, multilayer articles, or a pultruded article, and the like. In embodiments of a multilayer article, it is envisioned that at least one of the layers comprises the polymer composition of the present disclosure.

In one or more embodiments, polymer compositions may be used in the manufacturing of articles, including automotive parts, packaging for food products, chemicals, household chemicals, agrochemicals, fuel tanks, water and gas pipes, pipe coatings, geomembranes, and the like. Further examples of articles that may be produced using polymer compositions in accordance with the present disclosure include caps, closures, films, injected parts, hygienic absorbents, small volume blown articles, large volume blown articles, foams, expanded articles, thermoformed articles, household appliances, injected articles, domestic utilities, technical parts, air ducts, automotive parts and reservoirs, cylinders, perforated coils, geodesic blankets, bags, bags in general, housewares, diaper back cover, bedliner, cisterns, water boxes, boxes, bins, garbage collector, shoulders of pipes, tubes, ropes, oriented structures, biaxially-oriented films such as biaxial-oriented polypropylene (BOPP), plastic furniture, battery boxes, crates, plates, sheets, tubes, pipes, containers, electronic articles, textile articles, ribbons, raffia, tapes, filaments, drawers, ropes, fishing nets, technical coils, carpets, broomsticks, screens, archive tapes, bottles, profiles, thermal insulation, cups, pots, IBC (intermediate bulk container), packaging for cosmetics, packaging for hygiene and cleaning products, food packaging, multilayer packaging rigid, flexible multilayer packing, bungs, masterbatches, extrusion coating, packaging for pharmaceutical products, coextruded packaging, jars, tarpaulins, sacks, liner, laminate, tubes, kayaks, water tank, septic tanks, and other types of tanks.

Embodiments of the present disclosure may provide at least one of the following advantages. ICP compositions of one or more embodiments include a large amount of rubber, and thus, may exhibit unique characteristics. Notably, the ICP compositions may have improved impact resistance and eliminate tiger striping. Accordingly, TPO compositions that include the disclosed ICP also include a large amount of rubber and have unique characteristics. By replacing conventional external elastomers in TPO compositions with ICP composition in accordance with the present disclosure, such TPO compositions may have improved impact strength without any tiger stripes.

### Examples

An ICP with around 37% of XS was produced by Spheripol process, using a high porous phthalate catalyst, producing around 23-27% of rubber from a 1st GPR+10-12% rubber from a 2nd GPR. In both cases, a propylene-rich rubber was produced (i.e., containing less than 37% ethylene). An amorphous IV between 2.5 and 4.0 dL/g was measured at the first GPR. ICP-1 has an IV between 4.0-6.0 at the 2^{nd} GPR, while ICP-2 has an IV between 10.0-12.0 at the 2^{nd} GPR. The prepared ICP presented no break behavior at 23° C., around 200 J/m at −20° C. and around 90 J/m at −40° C.

The composition and properties of TPOs including the inventive ICP composition that were prepared are shown in Table 1, below. Such exemplary TPOs demonstrated that part of the conventional external elastomer could be replaced by the developmental grade ICP, keeping no failures at the falling dart test at −20° C. Similarly, rheological tests (tan S) showed the potential of the developmental grade ICP to reduce flow marks (i.e., tiger striping). Additional tests conducted at a Braskem partner (Produmáster) proved that at least ⅓ of a polyolefin elastomer could be replaced for the grade under development keeping the impact resistance of the final TPO, as shown in Table 1. Impact tests were performed using an Instron 9350, with a 125 mm thickness according to ASTM D3763.

| TPO | — | A | B | C |
|---|---|---|---|---|
| CP396XP | % | 50 | 0 | 0 |
| ICP-1 | | 0 | 55 | 0 |
| ICP-2 | | 0 | 0 | 52 |
| F350HC2 | | 24.6 | 24.6 | 27.6 |
| Talc Jetfine 3CW | | 15 | 10 | 10 |
| Engage 8407n | | 15 | 10 | 10 |
| Other Additives (Aos, NA11, | | 0.4 | 0.4 | 0.4 |
| Calcium Stearate) | | | | |
| Total Rubber content in TPO | | 29.5 | 30.1 | 29.5 |
| Screw rotation | rpm | 700 | 700 | 700 |
| Feed rate | lb/h | 50 | 50 | 50 |
| MFR 230/2.16 estimated | g/10 min | 20 | 19 | 16 |
| MFR 230/2.16 | g/10 min | 21.7 | 12.4 | 10.3 |

| Samples | Units | 1 | 5 | 7 | |
|---|---|---|---|---|---|
| Test temperature (falling dart) | ° C. | −30 | −30 | −30 | −20 |
| Average Puncture Energy | ft-lbf | 29.4 ± 0.5 | 29.0 ± 0.5 | 26.9 ± 0.8 | 25.9 ± 0.7 |
| Average Peak Force | lbf | 754 ± 10 | 706 ± 12 | 701 ± 6 | 634 ± 8 |
| Average Peak Energy | ft-lbf | 19.1 ± 0.4 | 18.6 ± 0.7 | 17.6 ± 0.4 | 16.3 ± 0.5 |
| Average Peak Displacement | in | 0.56 ± 0.00 | 0.57 ± 0.01 | 0.56 ± 0.1 | 0.57 ± 0.01 |
| Average Total Displacement | in | 0.87 ± 0.04 | 0.92 ± 0.04 | 0.76 ± 0.04 | 0.84 ± 0.05 |
| Specimens Ductile Break | Number | 10 | 10 | 1 | 10 |
| Specimens Brittle Break | | — | — | — | — |
| Specimens Ductile/Brittle Break | | — | — | 1 | — |
| Specimens Brittle/Ductile Break | | — | — | 8 | — |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An impact copolymer polypropylene (ICP) composition comprising:
a polypropylene-based matrix polymer; and
from 25 to 45 wt % of an ethylene-propylene copolymer rubber (EPR) phase, based on the total weight of the composition, wherein the EPR phase comprises 30 to 38 wt % ethylene and a xylene solubles (XS) content ranging from 25 to 45 wt % as determined by acetone precipitation, and
wherein the ICP composition has an Izod impact strength ranging from 180 to 600 J/m, as measured according to ASTM D256A at −20° C.

2. The composition of claim 1, wherein the EPR phase comprises two copolymer fractions, a first copolymer fraction (Fc1) being 55 wt % to 75 wt % of the total EPR phase and having an ethylene content from 30 to 40% and an amorphous intrinsic viscosity (IV_{Fc1}) of at least 2.0 dL/g, and not higher than 4.0 dL/g, as measured according to ASTM D445; and a second copolymer fraction (Fc2) having an intrinsic viscosity (IV_{Fc2}) of at least 6.0 dL/g, but not higher than 12 dL/g, as measured according to ASTM D445, and a propylene content ranging from 60 to 70%.

3. The composition of claim 1, wherein the polypropylene-based matrix polymer is present in an amount ranging from 55 to 75 wt %.

4. The composition of claim 1, wherein the composition has an amorphous intrinsic viscosity of 4.0 dL/g to 6.0 dL/g.

5. The composition of claim 1, wherein the ICP has an MFR of 5.0 to 30 g/10 min, as measured according to ASTM D1238 at 230° C. under a 2.16 kg load.

6. The composition of claim 1, wherein the polypropylene-based matrix polymer has an MFR of 50 to 250 g/10 min, as measured according to ASTM D1238 at 230° C. under a 2.16 kg load.

7. The composition of claim 1, wherein the ICP has an Izod impact strength ranging from 80 to 120 J/m, as measured according to ASTM D256A at −40° C.

8. An article comprising the composition of claim 1.

9. A thermoplastic polyolefin (TPO) composition comprising:
the impact copolymer polypropylene (ICP) composition according to claim 1; and
a polypropylene homopolymer;
wherein the TPO has an MFR ranging from 5.0 to 30 g/10 min, as measured according to ASTM D1238 at 230° C. under a 2.16 kg load.

10. The TPO composition of claim 9, wherein the ICP composition is present in an amount ranging from 20 to 60% by weight, and the polypropylene homopolymer is present at from 10 to 30% by weight, wherein the TPO composition further comprises:
from 0 to 10% by weight of a polyolefin elastomer;
from 0 to 20% by weight of talc; and
and optionally from 0 to 20% by weight of a standard ICP.

11. The TPO composition of claim 9, wherein the ICP composition is present in an amount ranging from 50 to 65% by weight, and the polypropylene homopolymer is present in an amount ranging from 35 to 50% by weight.

12. The TPO composition of claim 9, wherein the ICP composition has a tan S of less than 3.5 at 0.1 rad/s (180 C.).

13. The TPO composition of claim 9, wherein the TPO composition has a tiger marking onset distance of at least 75%.

14. The TPO composition of claim 9, wherein the TPO composition has an impact strength such that no failure is exhibited when tested by falling dart test −20° C. according to ASTM D1709.

15. An article comprising the composition of claim 9.

16. The article of claim 15, wherein the article is an automotive part.

17. A method of making an impact copolymer polypropylene (ICP) composition comprising:
polymerizing polypropylene via a bulk polymerization slurry process to provide a polypropylene-based polymer; and
polymerizing an ethylene-propylene rubber (EPR) phase in the presence of the polypropylene-based polymer and a highly porous organic catalyst to provide the EPR phase dispersed within the polypropylene-based polymer to produce the ICP composition according to claim 1.

18. The method of claim 17, wherein the polymerizing the EPR phase occurs in a plurality of gas phase reactors.

19. The method of claim 17, wherein the highly porous organic catalyst is a highly porous phthalate.

20. The method of claim 17, further comprising pelletizing the ICP composition to form a pelletized ICP composition.

21. The method of claim 20, further comprising forming the pelletized ICP composition into an article of manufacture.

22. The method of claim 18, wherein the method further comprises blending the ICP composition with a polypropylene homopolymer to form a thermoplastic polyolefin (TPO) composition.

23. The method of claim 22, further comprising pelletizing the TPO composition to form a pelletized TPO composition.

24. The method of claim 23, further comprising forming the pelletized TPO composition into an article of manufacture.
